(19) United States
(12) Patent Application Publication
(10) Pub. No.: US 2026/0244905 A1
(43) Pub. Date: Aug. 20, 2026

(54) SYSTEM AND METHOD FOR REDUCING SET SIZES FOR PROCESSING VIA CONFORMAL PREDICTION OPTIMIZATION AND FEEDING MODIFIED SET SIZES TO LARGE LANGUAGE MODEL

(71) Applicant: JPMorgan Chase Bank, N.A., New York, NY (US)

(72) Inventors: Harit VISHWAKARMA, Madison, WI (US); Alan MISHLER, Pittsburgh, PA (US); Thomas COOK, North Bergen, NJ (US); Niccolo DALMASSO, Long Island City, NY (US); Natraj RAMAN, London (GB); Sumitra GANESH, Short Hills, NJ (US)

(73) Assignee: JPMorgan Chase Bank, N.A., New York, NY (US)

(21) Appl. No.: 19/056,468

(22) Filed: Feb. 18, 2025

(51) Int. Cl. G06N 3/048; G06N 3/091

(52) U.S. Cl. CPC G06N 3/048; G06N 3/091

(57) ABSTRACT

Various methods and processes, apparatuses or systems, and media for performing a conformal prediction on an initial set of finite options generated by a large language model (LLM) are disclosed. The present disclosure provides receiving, via the LLM, a problem input in natural language including a question or prompt to select among a finite set of answer options as well as the answer options themselves; generating, via the LLM, a plurality of logits, wherein each of the plurality of logits correspond to the first set of finite answer options; generating, by executing a conformal prediction optimization (CP-OPT) framework, a score function for the LLM; and generating, via the score function, a conformal prediction set based on the first set of finite answer options, in which the conformal prediction set has a second set of finite answer options that is less than the first set of finite answer options, for improving accuracy of the LLM in identifying a correct answer to the problem input.

### TECHNICAL FIELD

This disclosure generally relates to optimizing conformal prediction for reducing set sizes and processing the reduced set sizes for improving accuracy of output while maintaining coverage.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Conventional large language models (LLMs) may be utilized to select an answer to a query among a finite set of answer options. For example, conventional LLMs may be utilized to answer multiple-choice questions (MCQs), and may be used in agent frameworks to select the correct tool or API to solve a task.

However, accuracy of the conventional LLMs on such tasks may vary substantially in that LLMs may often make overconfident, incorrect predictions, which may be risky in high-stake settings like healthcare or other high-stake industries. Accordingly, uncertainty associated with a provided response may need to be quantified so that a user may know how confident to be in a given answer, and the conventional LLM may route the question to a secondary model or a human when it is unable to provide answer with high confidence. However, the conventional LLM is incapable of accurately quantifying such uncertainty and is unable to distinguish between a high confidence answer and a low confidence answer, providing inconsistent and less reliable results. More specifically, although LLMs may be able to quantify their own uncertainty, such quantification by the LLMs have often been inaccurate.

As shown in FIG. 10, which illustrates a conventional operation of an LLM in the MCQ setting, a softmax score of 0.8 (i.e., 80%) was assigned by the LLM to answer option “D” among the four available answer options, higher than the scores assigned to the other three options. In this example, the LLM would predict “D” as the answer with high confidence, even though this answer is incorrect. In this scenario, the incorrectly provided answer by the LLM may incur a noticeable penalty for a downstream operation (e.g., automated payment schedule) that relies on the incorrectly provided answer.

Conformal prediction may refer to a framework that is applied to the LLM, and is separate from the LLM. Conventional applications of conformal prediction for MCQ type of settings have used readily available scores, such as logits output from the LLM, or have designed heuristic scores based for example on repeated querying of the LLM. However, logits can be overconfident and may show biases for some options among the finite options, and heuristic scores are not guaranteed to produce small sets. Accordingly, the conventional LLM is incapable of accurately quantifying such uncertainty and is unable to distinguish a high confidence answer from a low confidence answer, providing for appreciable amount of uncertainty in the use of the conventional conformal prediction framework.

### SUMMARY

The present disclosure, through one or more of its various aspects, embodiments, and/or specific features or sub-components, provides, among other features, a method for performing conformal prediction on an initial set of finite options provided to a large language model (LLM). The method is directed to provide a more useful measure of uncertainty in the conformal prediction and to reduce the amount of uncertainty present in the conventional conformal prediction framework. The method includes receiving, via the LLM, a problem input in natural language, including a question or prompt to select among a finite set of answer options as well as the answer options themselves; generating, via the LLM, a plurality of logits, in which each of the plurality of logits correspond to the first set of finite answer options; generating, by executing a conformal prediction optimization (CP-OPT) framework, a score function for the LLM; generating, via the score function, a conformal prediction set based on the first set of finite answer options, in which the conformal prediction set has a second set of finite answer options that is less than the first set of finite answer options; and inputting, to the LLM, the conformal prediction set and obtaining an answer to the received problem input, in which the conformal prediction set includes the answer to the received problem input.

In some embodiments, each of the plurality of logits correspond to an estimated probability of a correct answer to the problem input.

In some embodiments, the CP-OPT framework provides a score function that assigns scores to the first set of finite answer options and removes at least one answer option from the first set of finite answer options based on the assigned scores in the generating of the conformal prediction set.

In some embodiments, the second set of finite answer options includes a correct answer to the problem input according to a coverage guarantee.

In some embodiments, the conformal prediction set is a smaller set than the first set of finite answer options without a reduction in coverage guarantee.

In some embodiments, the at least one answer option is removed from the first set of finite answer options with a predetermined confidence level.

In some embodiments, the generating of the conformal prediction set includes: defining an expected set size and a coverage guarantee for an initial problem characterizing an optimal score function and a threshold; obtaining estimates for the expected set size and the coverage guarantee; generating a revised problem characterizing the optimal score function and the threshold; differentiating an objective and constraint of the revised problem by introducing surrogates and obtaining plugin estimates using the surrogates; replacing the expected set sizes by surrogates to transform to an unconstrained problem; introducing regularization to generate a modified problem characterizing the optimal score function and the threshold; solving the modified problem on a training dataset to yield a score function and threshold; and estimating a new threshold on a separate calibration set.

In some embodiments, the CP-OPT framework identifies at least one incorrect answer among the first set of finite answer options.

In some embodiments, the CP-OPT framework is a post-hoc application of conformal prediction to the LLM.

In some embodiments, the CP-OPT framework generates a score for each of the first set of finite answer options and identifies at least one incorrect answer among the first set of finite answer options.

In some embodiments, the conformal prediction set includes at least two answer options.

In some embodiments, the CP-OPT framework identifies an incorrect answer option for removal among the first set of finite answer options according to a predetermined confidence level.

In some embodiments, the predetermined confidence level is inputted by a user.

In some embodiments, the CP-OPT framework increases accuracy level of the LLM by 5%.

In some embodiments, a system for performing conformal prediction on an initial set of finite options provided to an LLM is disclosed. The system is directed to provide a more useful measure of uncertainty in the conformal prediction and to reduce the amount of uncertainty present in the conventional conformal prediction framework. The system may include: a processor configured to execute one or more applications; and a memory operatively connected to the processor via a communication interface, the memory storing computer readable instructions, when executed, causes the processor to perform: receiving, via the LLM, a problem input in natural language, including a question or prompt to select among a finite set of answer options as well as the answer options themselves; generating, via the LLM, a plurality of logits, in which each of the plurality of logits correspond to the first set of finite answer options; generating, by executing a conformal prediction optimization (CP-OPT) framework, a score function for the LLM; generating, via the score function, a conformal prediction set based on the first set of finite answer options, in which the conformal prediction set has a second set of finite answer options that is less than the first set of finite answer options; and inputting, to the LLM, the conformal prediction set and obtaining an answer to the received problem input, in which the conformal prediction set includes the answer to the received problem input.

In some embodiments, a non-transitory computer readable medium configured to store instructions for performing a conformal prediction on an initial set of finite options provided to an LLM is disclosed. The instructions are directed to provide a more useful measure of uncertainty in the conformal prediction and to reduce the amount of uncertainty present in the conventional conformal prediction framework. The instructions, when executed, may cause a processor to perform the following operations: receiving, via the LLM, a problem input in natural language, including a question or prompt to select among a finite set of answer options as well as the answer options themselves; generating, via the LLM, a plurality of logits, in which each of the plurality of logits correspond to the first set of finite answer options; generating, by executing a conformal prediction optimization (CP-OPT) framework, a score function for the LLM; generating, via the score function, a conformal prediction set based on the first set of finite answer options, in which the conformal prediction set has a second set of finite answer options that is less than the first set of finite answer options; and inputting, to the LLM, the conformal prediction set and obtaining an answer to the received problem input, in which the conformal prediction set includes the answer to the received problem input.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a CP-OPT system in accordance with an embodiment.

FIG. 2 illustrates a diagram of a network environment for implementing a CP-OPT system in accordance with an embodiment.

FIG. 3 illustrates a system configuration diagram for implementing a CP-OPT system in accordance with an embodiment.

FIG. 4 illustrates a method for machine learning scores that minimize set sizes while maintaining coverage in accordance with an embodiment.

FIG. 5 illustrates a CROQ method for narrowing down available choices to those in a prediction set for consideration by an LLM in accordance with an embodiment.

FIG. 6 illustrates a system flow for narrowing down available choices to those in a prediction set for consideration by an LLM in accordance with an embodiment.

FIG. 7 illustrates experimental results of an optimized CP score provided by a CP-OPT system that reduces set sizes while maintaining coverage guarantee and a CROQ implemented method that show an improvement in accuracy in accordance with an embodiment.

FIG. 8 illustrates accuracy charts indicating accuracy on revised questions on sample datasets while varying coverage parameter for different LLMs and both scores in accordance with an embodiment.

FIG. 9 illustrates sample results of a CROQ method on a sample dataset with finite response options in accordance with an embodiment.

FIG. 10 illustrates a conventional prediction operation of an LLM in a multiple question answering setting.

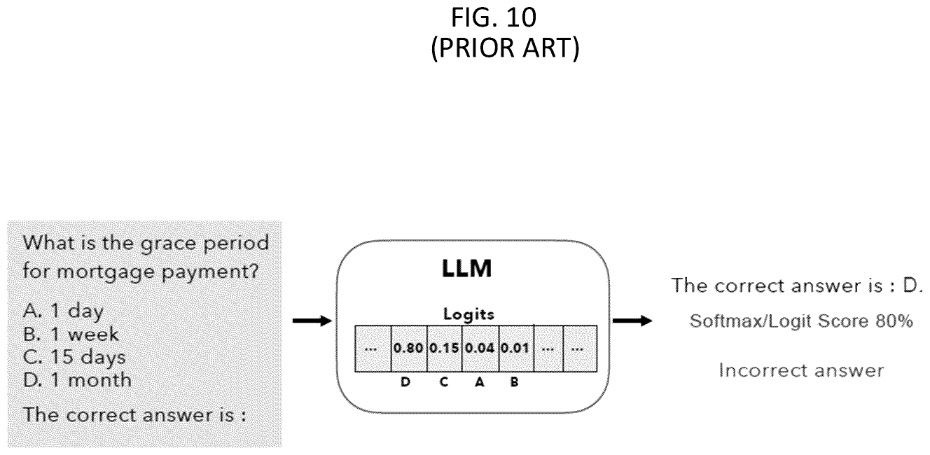

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

To mitigate the risks in the conventional LLMs, example aspects of the present disclosure provide an application of conformal prediction (CP), a model-agnostic framework for distribution-free uncertainty quantification. More specifically, CP may transform a score function into prediction sets that contain the true answer with high probability. While CP may provide a coverage guarantee for arbitrary scores, the score quality significantly impacts prediction set sizes. Conventional technologies have relied on LLM logits or other heuristic scores, which lack quality guarantees. Example aspects of the present disclosure address such limitations by introducing a CP optimization (CP-OPT) framework, which is an optimization framework to learn scores that minimize set sizes while maintaining coverage. Moreover, the CP-OPT framework may extend CP's utility beyond uncertainty quantification to improve accuracy of the LLM. More specifically, a conformal revision of questions (CROQ) method may be implemented to revise the problem by narrowing down the available choices to those in the prediction set. The coverage guarantee of CP may ensure that the correct choice is in the revised question prompt with high probability, while the smaller number of choices increases the LLM's chances of answering the inputted question correctly and reducing an amount of graphics processing unit (GPU) processing power for querying the LLM for identifying a correct answer among the smaller number of choices.

According to example aspects, the present disclosure provides (1) obtaining optimal scores for conformal prediction for MCQ and tool usage tasks in LLMs, and (2) utilizing the prediction sets generated by conformal prediction for improving downstream accuracy.

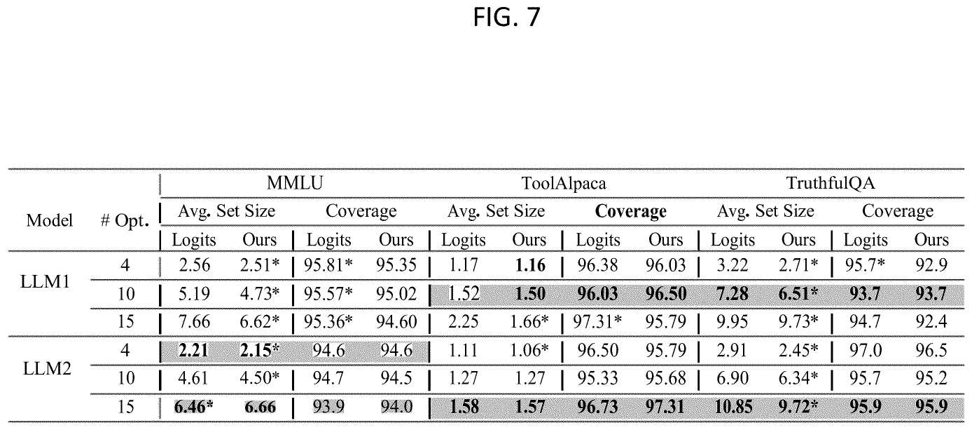

More specifically, a score function optimization or CP-OPT framework provided by the present disclosure may be applied to any pretrained LLM. Moving away from the potentially unreliable LLM logits and heuristic scores, the CP-OPT framework provides a principled way to perform machine learning of the scores for conformal prediction. As illustrated in FIG. 7, empirical results indicate implementation of CP-OPT framework leads to reduction in average set sizes in contrast to the baseline procedure that uses the LLM logits as the scores, at the same level (e.g., 95%) of marginal coverage.

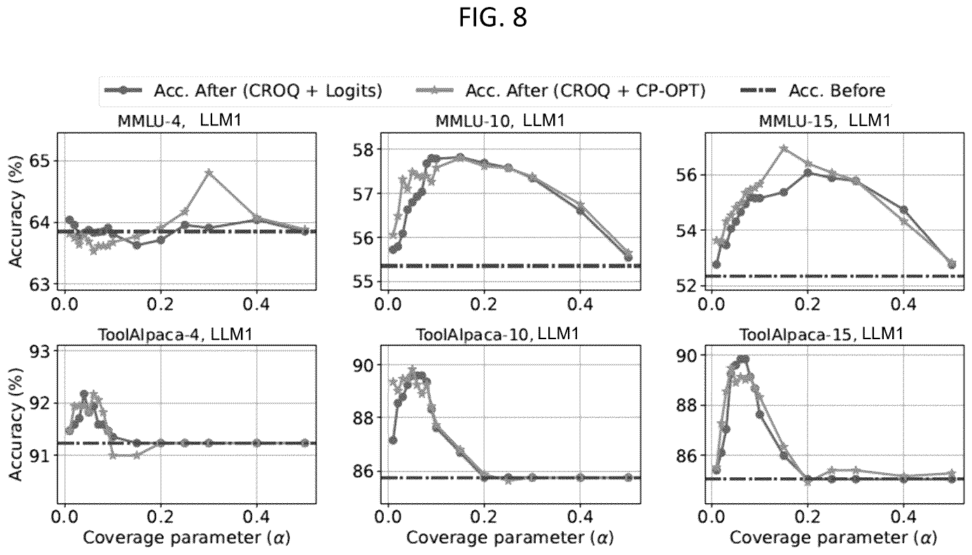

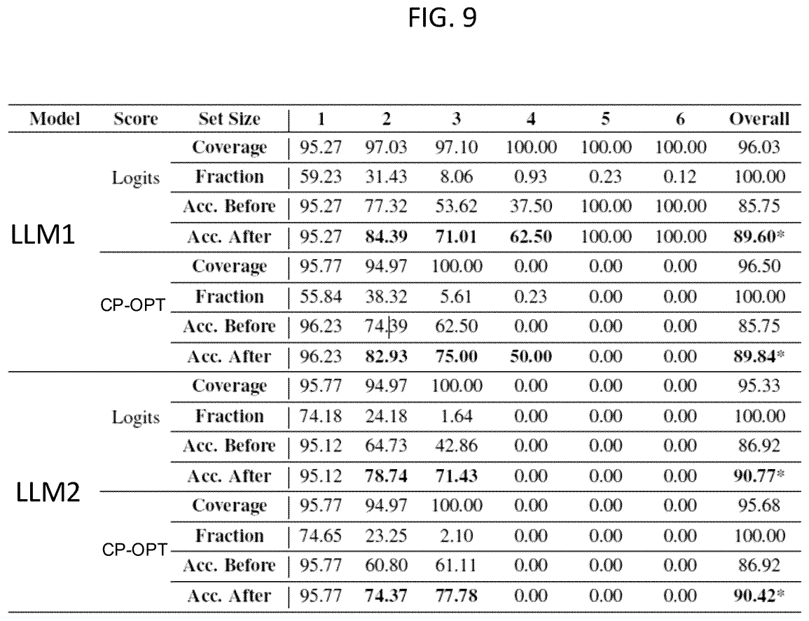

Further, extending the utility of conformal prediction beyond uncertainty quantification, the CROQ method may revise the question by narrowing down the choices to those in the prediction sets output by conformal prediction. Subsequent to narrowing down of the choices, the LLM may be re-prompted with the revised question. The CROQs may result in overall accuracy improvements of up to 5% (FIG. 8) and up to 14% on parts of a sample dataset with 10 options (FIG. 9).

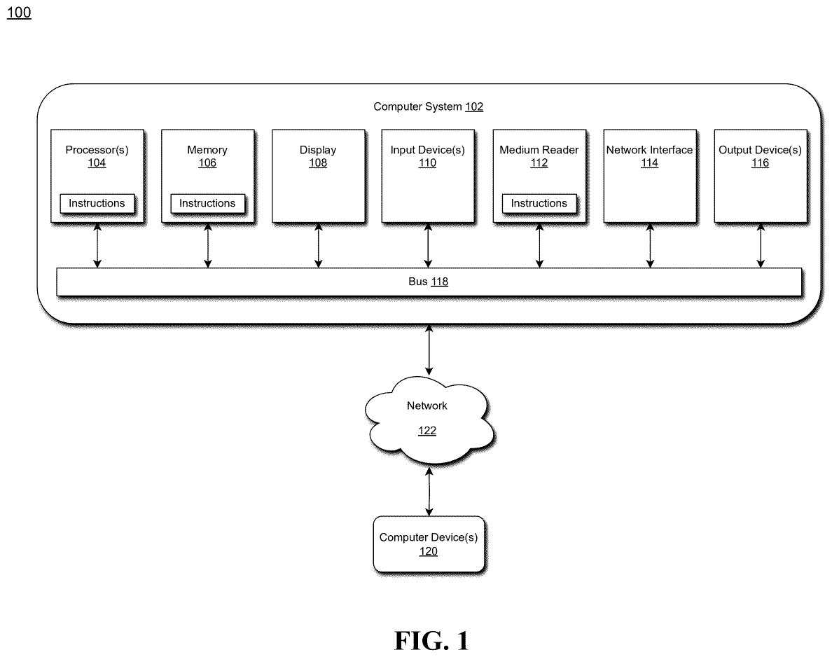

FIG. 1 is a system 100 for use in implementing a CP-OPT system in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a GPU, or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are mere examples and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are not meant to be exhaustive and/or inclusive.

In some embodiments, the conformal prediction optimization (CP-OPT) module or framework implemented by the system 100 may allow for a CP-OPT module or framework to learn or yield a score function, which may be utilized to process an initial set of finite answer options provided to an LLM. More specifically, the initial set of answer options provided to the LLM may be generated by obtaining a logit score for each possible token in sequence based on a problem text inputted to the LLM, and restricting the LLM to tokens that correspond to available answer keys and converting the logits to probabilities. The LLM may then generate, using the score function, a conformal prediction set that includes a set of finite answer options that is less than the initial set of finite answer options.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

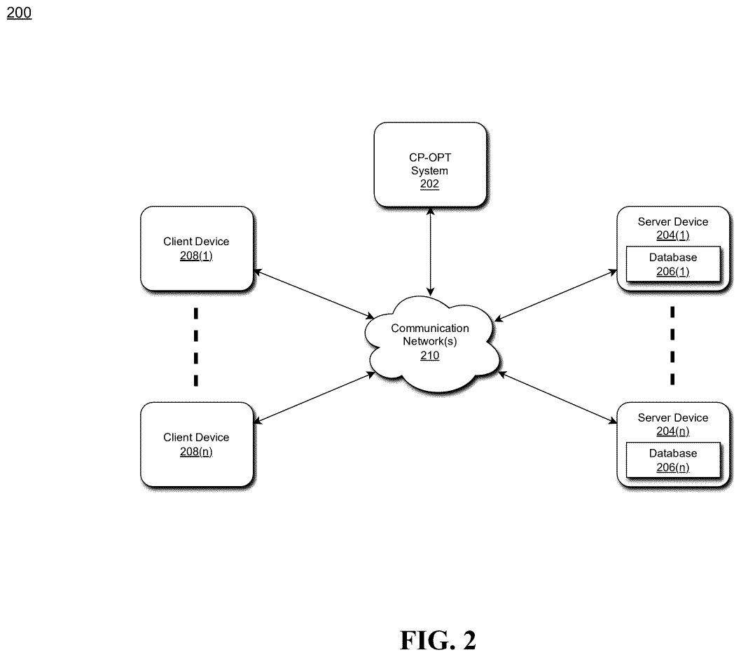

Referring to FIG. 2, a schematic of a network environment 200 for implementing a CP-OPT system is illustrated.

In some embodiments, the above-described problems associated with conventional knowledge graph completion tools may be overcome by implementing a CP-OPT system 202 as illustrated in FIG. 2 that may be configured for implementing a CP-OPT module configured for generating an ontological graph model based on a knowledge graph, and applying the generated ontological graph model to the LLM for performing a link prediction for the missing information in the knowledge graph for performance of the knowledge graph completion.

The CP-OPT system 202 may include one or more computer system 102s, as described with respect to FIG. 1, which in aggregate provide the necessary functions.

The CP-OPT system 202 may store one or more applications that can include executable instructions that, when executed by the CP-OPT system 202, cause the CP-OPT system 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CP-OPT system 202 itself, may be located in virtual server(s) running in a cloud-based computing environment rather than being tied to one or more specific physical network computing devices. Also, the application(s) may be running in one or more virtual machines (VMs) executing on the CP-OPT system 202. Additionally, in one or more embodiments of this technology, virtual machine(s) running on the CP-OPT system 202 may be managed or supervised by a hypervisor.

In the network environment 200 of FIG. 2, the CP-OPT system 202 may be coupled to a plurality of server devices 204(1)-204(n) that hosts a plurality of databases 206(1)-206(n), and also to a plurality of client devices 208(1)-208(n) via communication network(s) 210. A communication interface of the CP-OPT system 202, such as the network interface 114 of the computer system 102 of FIG. 1, operatively couples and communicates between the CP-OPT system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CP-OPT system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CP-OPT system 202 may be a standalone device or integrated with one or more other devices or apparatuses, such as one or more of the server devices 204(1)-204(n), for example. In one particular example, the CP-OPT system 202 may be hosted by one of the server devices 204(1)-204(n), and other arrangements are also possible. Moreover, one or more of the devices of the CP-OPT system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CP-OPT system 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the CP-OPT system 202 that may efficiently provide a CP-OPT module configured for generating, learning or yielding a score function, which may be utilized by an LLM to generate an optimized conformal prediction set that is smaller than an initial set provided to the LLM while maintaining a coverage guarantee for increasing accuracy of performance of the LLM as well as reduce GPU utilization by processing a smaller set of answer choices.

The client devices 208(1)-208(n) may run interface applications, such as standard web browsers or standalone client applications, which may provide an interface to communicate with the CP-OPT system 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the CP-OPT system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are examples, as many variations of the specific hardware and software used to implement the examples are possible, as may be appreciated by those skilled in the relevant art(s).

One or more of the devices depicted in the network environment 200, such as the CP-OPT system 202, the server devices 204(1)-204(n), or the client devices 208(1)-208(n), for example, may be configured to operate as virtual instances on the same physical machine. For example, one or more of the CP-OPT system 202, the server devices 204(1)-204(n), or the client devices 208(1)-208(n) may operate on the same physical device rather than as separate devices communicating through communication network(s) 210. Additionally, there may be more or fewer CP-OPT systems 202, server devices 204(1)-204(n), or client devices 208(1)-208(n) than illustrated in FIG. 2. In some embodiments, the CP-OPT system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

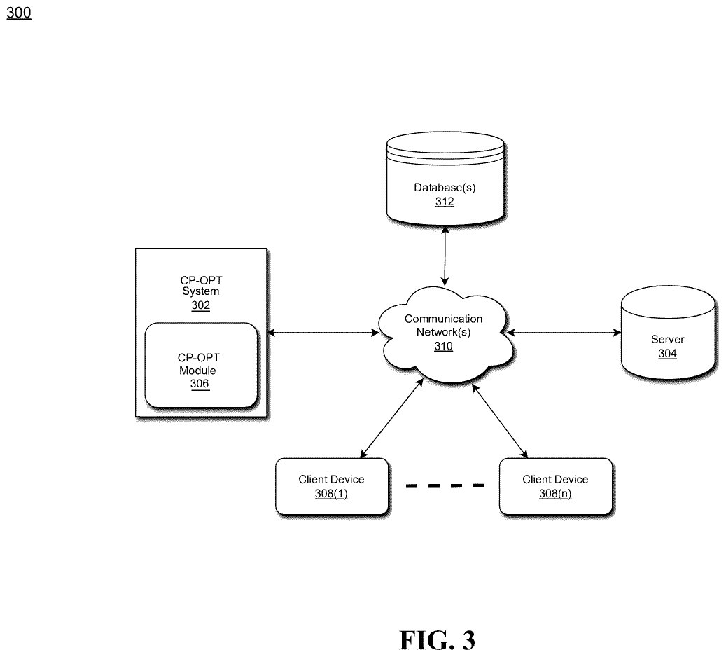

FIG. 3 illustrates a system diagram for implementing a CP-OPT system in accordance with an embodiment.

As illustrated in FIG. 3, the system 300 may include a CP-OPT system 302 within which a CP-OPT module 306 is embedded, a server 304, a database(s) 312, a plurality of client devices 308(1) . . . 308(n), and a communication network 310.

In some embodiments, the CP-OPT system 302 including the CP-OPT module 306 may be connected to the server 304, and the database(s) 312 via the communication network 310. The CP-OPT system 302 may also be connected to the plurality of client devices 308(1) . . . 308(n) via the communication network 310, but the disclosure is not limited thereto. The database(s) 312 may include one or more rule databases.

In an embodiment, the CP-OPT system 302 is described and shown in FIG. 3 as including the CP-OPT module 306, although it may include other rules, policies, modules, databases, or applications, for example. In some embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the CP-OPT module 306 may be configured to receive real-time feed of data from the plurality of client devices 308(1) . . . 308(n) and secondary sources via the communication network 310.

The CP-OPT module 306 may be configured to perform: receiving, via the LLM, a problem input in natural language including a question or prompt to select among a finite set of answer options as well as the answer options themselves; generating, via the LLM, a plurality of logits, wherein each of the plurality of logits correspond to the first set of finite answer options; generating, by executing a CP-OPT framework, a score function for the LLM; generating, via the score function, a conformal prediction set based on the first set of finite answer options, wherein the conformal prediction set has a second set of finite answer options that is less than the first set of finite answer options; and inputting, to the LLM, the conformal prediction set and obtaining an answer to the received problem input, wherein the conformal prediction set includes the answer to the received problem input, but the disclosure is not limited thereto.

The plurality of client devices 308(1) . . . 308(n) are illustrated as being in communication with the CP-OPT system 302. In this regard, the plurality of client devices 308(1) . . . 308(n) may be “clients” (e.g., customers) of the CP-OPT system 302 and are described herein as such. Nevertheless, it is to be known and understood that the plurality of client devices 308(1) . . . 308(n) need not necessarily be “clients” of the CP-OPT system 302, or any entity described in association therewith herein. Any additional or alternative relationship may exist between either or both of the plurality of client devices 308(1) . . . 308(n) and the CP-OPT system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the CP-OPT system 302 via broadband or cellular communication. Of course, these embodiments are merely examples and are not limiting or exhaustive.

The computing device 301 may be the same or similar to any one of the client devices 208(1)-208(n) as described with respect to FIG. 2, including any features or combination of features described with respect thereto. The CP-OPT system 302 may be the same or similar to the CP-OPT system 202 as described with respect to FIG. 2, including any features or combination of features described with respect thereto.

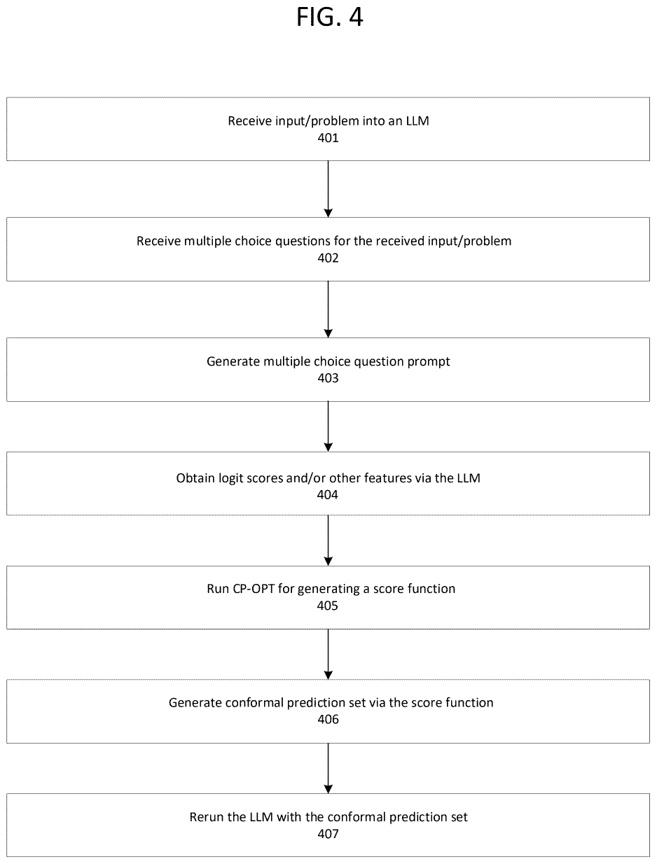

FIG. 4 illustrates a method for performing a link prediction by feeding knowledge graph into a LLM in accordance with an embodiment.

A conformal prediction framework may be utilized to quantify uncertainty with LLM outputs. The conformal prediction may produce sets of possible answers that may be guaranteed to contain the correct answer with at least a predetermined probability or confidence level (e.g., 95%). According to example aspects, different conformal prediction methods may produce various set sizes. However, the conformal prediction framework may be more useful in smaller sets on average, since when sets are too large (e.g., if they contain every possible answer), the conformal prediction framework may be less useful.

In view of the above noted limitations, aspects of the present disclosure provides a CP-OPT framework for learning a function that may be used to produce conformal prediction sets that are smaller on average than the sets produced using the LLM's logits. The learned function may also be referred to as a score function. The LLM, as explained in more detail below, may reduce the size of the conformal prediction sets compared to a conventional baseline approach by utilizing the score function learned or provided by the CP-OPT framework.

Example aspects of the present disclosure also provides a CROQ method, which involves a first query to an LLM, which may be used to construct a conformal prediction set and then a second query to the LLM which only offers as options the answers contained in the conformal prediction set. By eliminating incorrect options (with high probability) in the first query, the final accuracy of the LLM may be improved in the second step. The CROQ method may involve a specific manner of iteratively querying the LLM, which provides an increase in the final accuracy in output of the LLM.

Moreover, the CP-OPT framework and the CROQ method may be further leveraged, such that the LLM is configured to defer to a secondary artificial intelligence (AI) or machine learning (ML) model or to a human when the size of the conformal set is above a certain threshold to increase overall accuracy.

According to example aspects, the CP may refer to a framework that may be used to quantify uncertainty in LLMs. In an example, conformal prediction may be a model-agnostic and distribution-free technique for producing prediction sets that contain the true outcome with a user-specified probability (e.g., 95%). Set sizes may provide a natural measure of uncertainty, with small sets representing low uncertainty and large sets representing high uncertainty.

According to example aspects, construction of sets in conformal prediction may depend on a score function, which may measure how well a candidate output “conforms” to a given input. For example, in classification settings, it may be common to use the classifier logits corresponding to each class for a given input as the score function. While conformal prediction gives a coverage guarantee for any scoring or score function, the size of the output sets may depend on the scoring function that is used. For example, a random scoring function may yield output sets that constitute random subsets of the label space that are large enough to satisfy the coverage guarantee.

In addition to providing a measure for uncertainty inherent in outputs generated by the LLMs, the sets produced by the conformal prediction may be leveraged for other downstream purposes. More specifically, by revising a multiple choice question or tool usage prompt to include only the options within a conformal prediction set, the LLM may be more likely to provide the correct answer due to the reduced number of choices, leading to improved accuracy.

In operation 401, a question or an input is provided to an LLM. According to example aspects, the LLM may be pre-trained with one or more training datasets. The LLM may be an auto-regressive language model based on a transformer architecture. Further, the LLM may be instruction-tuned, open-weight, and a small to medium sized model, for reproducibility and reduced computational resource expenditure. Moreover, the question or the input provided to the LLM may elicit a response among finite available options. In an example, the question may be provided in a natural language text.

In operation 402, multiple choice questions (MCQs) or finite listing of possible answers may be provided to the LLM in response to the inputted question. According to example aspects, operations 401 and 402 may be performed in a single operation or multiple operations. According to further aspects, the MCQs may be a general abstraction for expressing problems in which the correct choice must be selected from a given set of choices. An MCQ may consist of question text Q (i.e., a sequence of tokens), and a set of answer choices O={(Y₁, V₁), (Y₂, V₂), . . . , (Yₘ, Vₘ)}. Here, each Yⱼ is a unique character from the English alphabet, and the number of choices may be less than or equal to the size of the alphabet. Further, each Vⱼ may refer to option text for the jth option. The whole MCQ instance may be denoted as x=(Q,O). Moreover, Xₘ may denote the space of MCQs with m choices and P_{Xm} denote a distribution over Xₘ, from which samples for training, calibration and testing are drawn independently. In an example, for each question Q, there may be only one correct answer key y*=∈{Y₁, Y₂, . . . . Yₘ}=Yₘ.

In operation 403, question text Q and the answer choices O may be concatenated, all separated by a new line character. The concatenated question text and answer choices may be appended to the end of a predetermined text, such as “The correct answer is:”. According to example aspects, given such input prompt, the next token predicted by the LLM may be one of the option keys. According to further aspects, prefix and suffix tokens may be added to the prompt as recommended by the language model providers. The above noted modifications may be fixed modifications to x, and x may be used to denote the final prompt and the MCQ instance analogously.

In operation 404, logit scores and/or other features are obtained via the LLM for the received input or problem. According to example aspects, an LLM inference may be performed. More specifically, auto-regressive LLM may be queried on the input or problem to obtain logit scores for each possible next token given the question prompt, restricting attention to the tokens that correspond to the available answer keys (e.g., “a,” “b,” “c” and “d” if there are four answer options). The logits are then converted to probabilities, and the LLM's answer is allocated to one of the available answer options based on the highest probability. Such an approach ensures that the LLM's answer corresponds to one of the available answer options, which may not be guaranteed if the LLM was instead asked to simply generate an answer token in response to the inputted prompt or question.

In operation 405, the CP-OPT system is executed for generating a score function, which may be utilized by the LLM for reducing set sizes. In an example, the score function may be generated or learned using the logit scores and/or other features obtained from the LLM in operation 404. According to example aspects, CP may refer to a framework for quantifying uncertainty in machine learning models. The prediction sets may contain a true output or label with a probability that is specified by the user, e.g., 95%. A strength of the CP framework includes its distribution-free guarantees, which ensures that the constructed prediction sets are valid regardless of the underlying data distribution and model. Such property may be applied in the context of language models, where it may be difficult to characterize language data distributions or put specific distributional assumptions/restrictions on the LLMs.

According to further aspects, a conformal score function (R) represented by g: Xₘ×Yₘ→R may indicate a degree of agreement between two variables, such as variable x and variable y, where a larger score indicates a better agreement. Here, g may refer to a fixed conformity score function. In this regard, large scores may indicate that y is a plausible output given x input, while smaller scores indicate less plausibility. However, aspects of the present disclosure are not limited thereto, such that some may interpret an opposite relationship, such that larger scores may indicate a greater disagreement.

Moreover, given a threshold t on the scores, the prediction set for any x∈Xm is given by:

$$C ( x \vert g , τ ) : = \{ y ∈ {Y}_{m} : g ( x , y ) \geq τ \} .$$

According to further aspects, the ≥sign would be reversed, if the larger scores were interpreted to indicate a greater disagreement rather than greater agreement.

Based on the above relationship, larger sets may represent greater uncertainty, while smaller sets represent less uncertainty. More specifically, in consideration of the above noted relationship, two different score functions may be compared given a fixed confidence level, where a score function which produces larger sets may be said to result in greater uncertainty.

According to example aspects, given a scoring function: Xₘ×Yₘ→R, split conformal prediction may use a calibration dataset

$${D}_{cal} = {\{ {x}_{i} , {y}_{i}^{*} \}}_{i = 1}^{{n}_{cal}}$$

to compute a threshold [symbol] , defined as:

$$\hat{τ} = min \{ q : \frac{1}{{n}_{cal}} {\sum }_{i = 1}^{{n}_{cal}} \text{?} ( ℊ ( {x}_{i} , {y}_{i}^{*} ) \leq q ) \geq α \} ,$$

where α∈[0, 1] may refer to a user-chosen error rate that is equal to 1 minus the desired coverage, for example a value of α=0.05 would correspond to a coverage of 95%. In other words, [symbol] may refer to the smallest empirical quantile of the scores for the correct answers on the calibration dataset that is sufficient to satisfy the coverage property. The threshold [symbol] may be used to construct prediction sets C(x|g, [symbol] ) on previously unseen test points. This procedure may benefit from a marginal coverage guarantee for prediction sets constructed on unseen test data points.

According to further aspects, for marginal coverage guarantee, g may refer to a fixed conformity score function and [symbol] may refer to an a threshold computed via split conformal prediction on

$${D}_{cal} = {\{ {x}_{i} , {y}_{i}^{*} \}}_{i = 1}^{{n}_{cal}} \sim {ℙ}_{{𝒳}_{m} \times {𝒴}_{m}} .$$

Then, for a new sample (\tilde{x},\tilde{y}*)~ [symbol] ₓ_{ₘ}_{×y}_{ₘ}, [symbol] (\tilde{y}*∈C(\tilde{x}|g, [symbol] )≥1−α may be provided, where the probability is marginal over the randomness in the calibration data and the new sample.

In operation 406, conformal prediction set is obtained from the LLM using the score function provided by the CP-OPT system or framework.

According to example aspects, conformal prediction sets may be used for downstream purposes other than uncertainty quantification, including improving the final accuracy in MCQ type tasks. In this regard, the conformal prediction set may provide a reduced set of answer options that may be utilized to re-prompt the LLM in operation 407.

Initially, the scoring function provided via CP-OPT may be used to run a split conformal procedure with coverage level 1−α for some α∈[0, 1] to estimate the threshold [symbol] , which is then utilized for obtaining the conformal prediction set.

In an example, given a test instance x, a first stage prediction set C(x|g, [symbol] ) may be generated. Per the coverage guarantee provided via [symbol] (\tilde{y}*∈C(\tilde{x}|g, [symbol] ))≥1−α, true answer of y*∈C(x|g, [symbol] ) with a probability of 1−α may be expected.

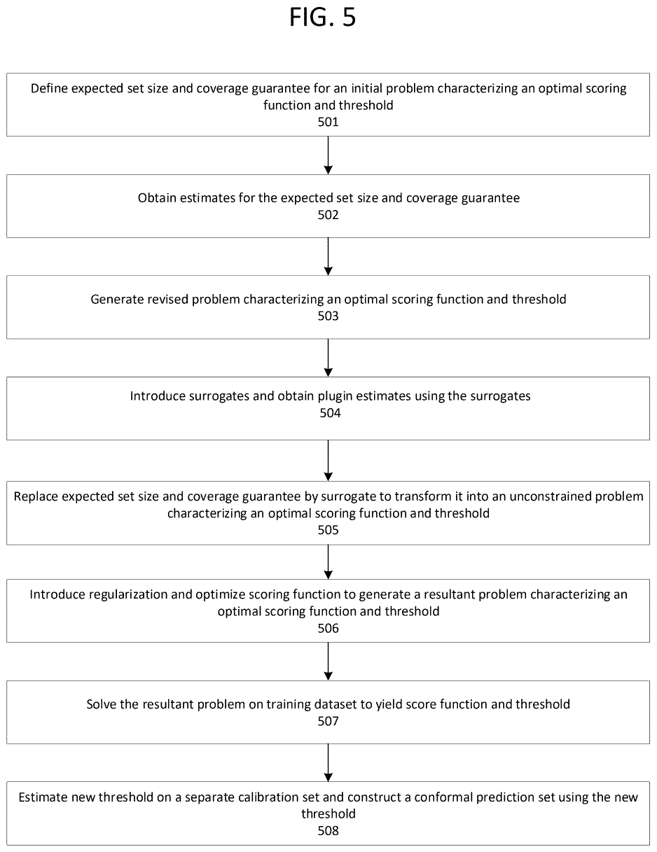

According to example aspects, a score function yielded by the CP-OPT framework or system may yield smaller sets than those generated by a conformal prediction procedure which directly utilizes the LLM's logits for reducing uncertainty. Detailed description for obtaining optimal scores that generate smallest sets and reduce uncertainty in output, which resultingly increases accuracy in the LLM output, may be provided with respect to FIG. 5 provided below.

In operation 407, the LLM is run for a second time with the conformal prediction for providing an output for the inputted problem. According to example aspects, if the first stage prediction set C(x|g, [symbol] ) is empty or is of size l or size m (corresponding to the number of answer options), then the LLM's default answer may be utilized, since the conformal procedure may not result in additional information. Otherwise, inputted prompt x may be modified to x′=(Q, O′), where O′={(Kⱼ, Vⱼ):Kⱼ∈C(x|g, [symbol] )}. The keys in O′ are changed so that they start with the first letter of the alphabet and go to the letter corresponding to the number of choices available. For example, if there were initially four answer options {a, b, c, d}, and the conformal prediction set was {c, d}, then the two options in the set would receive new keys {a, b}. Then x′ may be transformed into a prompt format and input into the LLM and the inference procedure may be run to extract the predicted answer key ŷ′.

According to further aspects, conformal inference may be leveraged to eliminate incorrect answer choices among the available answer choices. Once some of the answer choices are eliminated as incorrect answer choices, there is a reduction in uncertainty in the remaining answer choices for selection. Accordingly, chances of selecting a correct answer among the remaining answer choices may be higher. While there is only one agent, namely the LLM, meaning there is no external entity with oracle knowledge of the correct answer, the conformal guarantee ensures that the eliminated answers are all incorrect answers with high probability (e.g., 95%).

FIG. 5 illustrates a CROQ method for narrowing down available choices to those in a prediction set for consideration by an LLM in accordance with an embodiment.

In operation 501, expected set sizes and coverage condition may be defined for an initial problem (P1) that characterizes an optimal scoring or score function and a threshold. For any scoring function g: Xₘ×Yₘ→R and threshold τ, the membership of any y in the prediction set C(x|g, τ) is given by 1(y∈C(x|g, τ))⇐⇒1{g(x, y)≥τ}. The expected set size S(g, τ) and a corresponding coverage conditional on t (which may be referred to as coverage guarantee), denoted P(g, τ), as follows:

$$S ( ℊ , τ ) := {𝔼}_{x \sim {𝒳}_{m}} [ {\sum }_{y ∈ {𝒴}_{m}} \text{?} \{ ℊ ( x , y ) \geq τ \} ] = {\sum }_{y ∈ {𝒴}_{m}} {𝔼}_{x \sim {𝒳}_{m}} [ \text{?} \{ ℊ ( x , y ) \geq τ \} ] ,$$

$$𝒫 ( ℊ , τ ) := {𝔼}_{x \sim {𝒳}_{m}} [ \text{?} \{ ℊ ( x , {y}^{*} ) \geq τ \} ] .$$

The optimal scoring function g* and threshold τ* may be defined as problem (P1) to minimize the expected set subject to the coverage P(g, τ) being at least

$$g ★ , τ★ := arg min S ( g , τ ) s . t . P ( g , τ ) \geq 1 - α .$$

$$g : {X}_{m} \times {Y}_{m} \to R , τ ∈ R$$

In operation 502, estimates for the expected set size and the corresponding coverage guarantee are obtained. In practice, the distribution and access to the quantities for the expected set size and the corresponding coverage guarantee may not always be available. Instead, estimates for the distribution, expected set size and the coverage conditional on τ may be obtained using a finite training sample

$${D}_{train} = {\{ ( {x}_{i} , {y}_{i}^{*} ) \}}_{i = 1}^{{n}_{i}}$$

drawn independently from the same distribution.

$$\hat{S} ( ℊ , τ ) := \frac{1}{n} {\sum }_{i = 1}^{n} {\sum }_{y ∈ {𝒴}_{m}} \text{?} \{ ℊ ( {x}_{i} , y ) \geq τ \} , \hat{P} ( ℊ , τ ) := \frac{1}{n} {\sum }_{i = 1}^{n} \text{?} \{ ℊ ( {x}_{i} , {y}_{i}^{*} ) \geq τ \} .$$

In operation 503, using these plug-in estimators for the expected set size and the corresponding coverage guarantee may yield a revised optimization problem. However, it may be difficult to solve this revised optimization problem as the objective and constraints are not differentiable. To make them differentiable, surrogates may be introduced in operation 504. Accordingly, given g(x, y) and τ, a sigmoid function may be defined with β>0, σ(x, y, g, τ, β): l/(1+exp(exp(−β(g(x, y)−τ)). The sigmoid function may provide a differentiable approximation to the indicator variable for g(x, y)≥τ. The approximation may be tighter with higher β i.e., σ(x, y, g, τ, β)→l{g(x, y)≥τ} as β→∞, and g(x, y)≥τ⇐⇒σ(x, y, g, τ)≥½. By using these sigmoid surrogates in the above noted equation, the following smooth plugin estimates:

$$\tilde{S} ( ℊ , τ ) := \frac{1}{n} {\sum }_{i = 1}^{n} {\sum }_{y ∈ {𝒴}_{m}} σ ( {x}_{i} , y , ℊ , τ , β ) , \tilde{𝒫} ( ℊ , τ ) := \frac{1}{n} {\sum }_{i = 1}^{n} σ ( {x}_{i} , {y}_{i}^{*} , ℊ , τ , β ) .$$

Based on the above, that as n, β→∞, the surrogate average set size and coverage will converge to their population versions, [symbol] (g, [symbol] )→S(g, [symbol] ) and [symbol] (g, [symbol] )→ [symbol] (g, [symbol] ). In operation 505, the expected set size and marginal coverage are replaced by smooth surrogates in the initial problem P1 and transformed into an unconstrained problem with the penalty term λ>0. In addition, [symbol] regularization may be introduced in operation 506 to encourage low norm solutions. Moreover, the scoring function g may be optimized over a flexible space of functions G. Resulting problem (P2) may be generated and differentiable. In operation 507, the resulting problem P2 may be solved on a training dataset

$${D}_{train} = {\{ ( {x}_{i} , {y}_{i}^{*} ) \}}_{i = 1}^{{n}_{train}}$$

using stochastic gradient descent. The resulting problem P2 may be defined as provided below:

$$\tilde{ℊ} , \tilde{τ} := {arg min}_{ℊ ∈ 𝒢 , τ ∈ ℝ} \tilde{S} ( ℊ , τ ) + {λ ( \tilde{𝒫} ( ℊ , τ ) - 1 + α )}^{2} - \hat{𝒞} ( ℊ ) + {λ}_{2} {‖ ℊ ‖}_{2}$$

According to example aspects,

$$\hat{𝒞} ( ℊ ) := \frac{1}{{n}_{train}} {\sum }_{i = 1}^{{n}_{train}} log ( ℊ ( {x}_{i} , {y}_{i}^{*} ) )$$

may refer to the cross entropy term included to encourage higher scores for correct predictions and λ₂∥g∥₂ is the regularization term for g to promote low norm solutions. Solving problem P2 may yield a score function \tilde{g} and a threshold [symbol] . However, [symbol] may be biased since it is estimated on the same data as \tilde{g}. In operation 508, following the split conformal procedure, a new threshold [symbol] may be estimated on a separate calibration dataset. The new threshold [symbol] may be used to construct a conformal prediction set for previously unseen test points. In an example, a score function g may be trained using LLM's logits and penultimate layer's representations corresponding to the last token as features. Moreover, the score function g may be machine learned from a function class of 3-layer neural networks with tanh activation. Further, the CP-OPT framework is flexible and may work with any choice of features and function class for which [symbol] norm may be calculated.

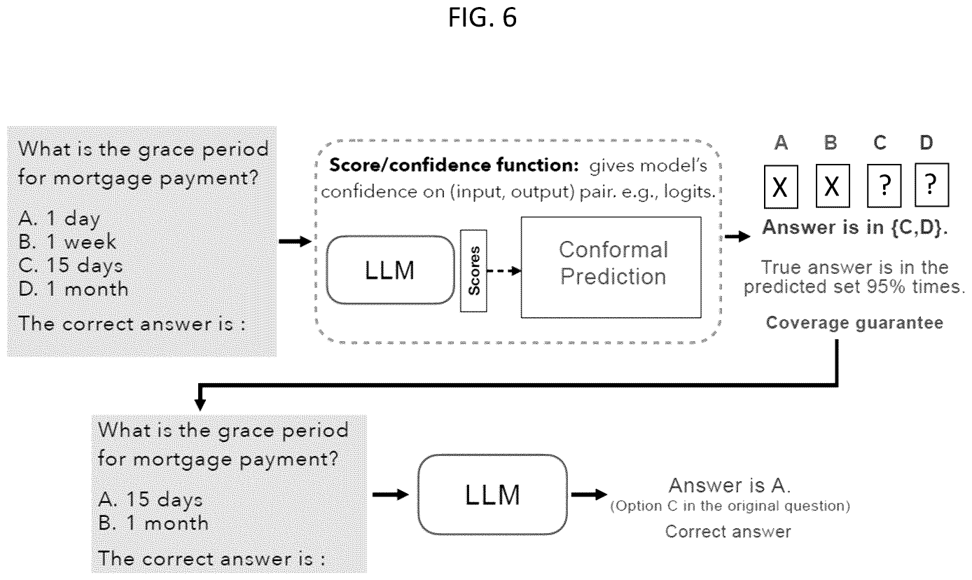

FIG. 6 illustrates a system flow for narrowing down available choices to those in a prediction set for consideration by an LLM in accordance with an embodiment.

As illustrated in FIG. 6, a post-hoc method for applying a conformal prediction to an LLM is provided. More specifically, in the LLM, a score/confidence function yielded by the CP-OPT framework may be applied to each of the answer options included in the MCQs provided to the LLM for performing a conformal prediction. Based on the score/confidence function, the answer options in the MCQs may be narrowed down to a smaller set size (i.e., from an initial set of a, b, c and d to a modified set of c and d) by eliminating one or more answer options with 95% confidence. Then, the modified or smaller set of answer options, which may be referred to as a prediction set, is submitted to the LLM for a selection of an answer option among the modified or smaller set of answer options. More specifically, the question and labels are revised to contain only the answer choices in the modified or smaller set of answer options and the LLM is re-prompted with the revised question. The re-prompting of the LLM with the reduced answer choices may improve chances of obtaining the correct answer since the probabilities are split among the modified set instead of the full set of answer options.

FIG. 7 illustrates experimental results of an optimized CP score provided by a CP-OPT system that reduces set sizes while maintaining coverage guarantee and a CROQ implemented method that shows an improvement in accuracy in accordance with an embodiment.

As illustrated in FIG. 7, a table of average set sizes and coverage rates (in percentages) for conformal prediction sets on the MMLU, ToolAlpaca and TruthfulQA datasets using a large language model No. 1 (LLM1) and a large language model No. 2 (LLM2) with a target coverage level of 95% is provided. According to example aspects, the MMLU dataset may focus on assessing multitask accuracy, containing MCQs from 57 domains, including humanities, math, medicine and etc. The TruthfulQA dataset may evaluate an LLM's ability to answer truthfully and not mimic preconceived falsehoods that humans may be susceptible to. ToolAlpaca contains 3.9 k tool-use instances from a multi-agent simulation environment, which may be augmented to a MCQ format.

For each dataset, the number of answer options have been varied. As shown in FIG. 7, using the score function yielded by the CP-OPT framework produces smaller average set sizes more frequently compared to using the default logits of the LLM. Bold numbers indicate smaller average set sizes. Shaded cells indicate settings where the LLM utilizing the score function results in smaller set sizes and equal or larger coverage. Asterisks on the larger of a pair of numbers indicate whether the difference in average set size or coverage is statistically significant at the α=0.05 level.

FIG. 8 illustrates accuracy charts indicating accuracy on revised questions on sample datasets while varying the coverage parameter for different LLMs and both scores in accordance with an embodiment.

Accuracy on revised questions (e.g., smaller sets of answer options) on the MMLU and ToolAlpaca dataset while varying the coverage parameter α for LLM1 and both scores is illustrated in FIG. 8. As shown in FIG. 8, smaller values of a correspond to high levels of coverage. When coverage is too large, few or no answers are eliminated. When coverage is low, a larger portion of answer sets no longer contain the true answer or produce empty prediction sets, thus resulting in diminished benefits of revision.

FIG. 9 illustrates sample results of the CROQ method on a sample dataset with finite response options in accordance with an embodiment.

According to example aspects, results for a CROQ experiment on the ToolAlpaca dataset with 10 response options are illustrated in FIG. 9. Here, α is set to 0.05, and questions are binned according to set sizes. Reporting of coverage, fraction of points, accuracy before CROQ and accuracy after CROQ is provided in each bin. As shown in FIG. 9, consistent improvement in the overall accuracy by around 4% across all model and score combinations, and about 14% on questions with set size 2, with LLM2, amounting to about 24% of the questions may be seen in FIG. 9.

According to example aspects, conformal prediction may be used to quantify and reduce output uncertainty for decision-making problems, such as multiple-choice question answering (MCQ) with LLMs. An optimal conformal score function (P1) that minimizes average set size subject to a coverage constraint is defined. Moreover, estimating the average set size subject to the coverage constraint using a differentiable loss function that can be optimized via stochastic gradient descent (P2) is defined.

As described above, utilization of a score function yielded by the CP-OPT framework or system results in smaller average set sizes than the baseline score function consisting of LLM logits corresponding to the MCQ answer options. According to example aspects, the CP-OPT framework yielded score function may be applied with different models, features sets and the like.

Further, re-prompting the LLM with the answer options contained in the conformal prediction set (i.e., modified answer option set) may result in higher accuracy on MCQ tasks. Such a procedure may be referred to as the CROQ method. The conformal prediction sets will contain the true answer with high probability while potentially substantially reducing the number of answer options the LLM has to consider. The CROQ method may increase accuracy in most of the cases and there is an interplay between the coverage level and the accuracy improvement that may be optimized.

Although the invention has been described with reference to several example embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, example embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for performing a conformal prediction on an initial set of finite options to a large language model (LLM), the method comprising:
receiving, by the LLM executed by a processor, a problem input in natural language including a question or prompt to select among a finite set of answer options as well as the answer options themselves;
generating, by the LLM, a plurality of logits, wherein each of the plurality of logits correspond to the first set of finite answer options;
generating, by executing a conformal prediction optimization (CP-OPT) framework, a score function for the LLM;
generating, via the score function executed by the processor, a conformal prediction set based on the first set of finite answer options, wherein the conformal prediction set has a second set of finite answer options that is less than the first set of finite answer options; and
inputting, to the LLM, the conformal prediction set and obtaining an answer to the received problem input, wherein the conformal prediction set includes the answer to the received problem input.

2. The method according to claim 1, wherein each of the plurality of logits correspond to an estimated probability of a correct answer to the problem input.

3. The method according to claim 1, wherein the score function assigns scores to the first set of finite answer options and removes at least one answer option from the first set of finite answer options based on the assigned scores in the generating of the conformal prediction set.

4. The method according to claim 1, wherein the second set of finite answer options includes a correct answer to the problem input according to a coverage guarantee.

5. The method according to claim 1, wherein the conformal prediction set is a smaller set than the first set of finite answer options without a reduction in coverage guarantee.

6. The method according to claim 3, wherein the at least one answer option is removed from the first set of finite answer options with a predetermined confidence level.

7. The method according to claim 1, wherein the generating of the conformal prediction set comprises:
defining an expected set size and a coverage guarantee for an initial problem characterizing an optimal score function and a threshold;
obtaining estimates for the expected set size and the coverage guarantee;
generating a revised problem characterizing the optimal score function and the threshold;
differentiating an objective and constraint of the revised problem by introducing surrogates and obtaining plugin estimates using the surrogates;
replacing the expected set sizes by surrogates to transform to an unconstrained problem;
introducing regularization to generate a modified problem characterizing the optimal score function and the threshold;
solving the modified problem on training dataset to yield a score function and threshold; and
estimating a new threshold on a separate calibration set.

8. The method according to claim 1, wherein the CP-OPT framework identifies at least one incorrect answer among the first set of finite answer options.

9. The method according to claim 1, wherein the CP-OPT framework is a post-hoc application of a conformal prediction to the LLM.

10. The method according to claim 1, wherein the CP-OPT framework generates a score for each of the first set of finite answer options and identifies at least one incorrect answer among the first set of finite answer options.

11. The method according to claim 1, wherein the conformal prediction set includes at least two answer options.

12. The method according to claim 1, wherein the CP-OPT framework identifies an incorrect answer option for removal among the first set of finite answer options according to a predetermined confidence level.

13. The method according to claim 12, wherein the predetermined confidence level is inputted by a user.

14. The method according to claim 1, wherein the CP-OPT framework increases accuracy level of the LLM by 5%.

15. A system for performing a conformal prediction on an initial set of finite options provided to a large language model (LLM), the system comprising:
a processor; and
a memory operatively connected to the processor via a communication interface, the memory storing computer readable instructions, when executed, causes the processor to perform:
receiving, via the LLM, a problem input in natural language, including a question or prompt to select among a finite set of answer options as well as the answer options themselves;
generating, via the LLM, a plurality of logits, wherein each of the plurality of logits correspond to the first set of finite answer options;
generating, by executing a conformal prediction optimization (CP-OPT) framework, a score function for the LLM;
generating, via the score function, a conformal prediction set based on the first set of finite answer options, wherein the conformal prediction set has a second set of finite answer options that is less than the first set of finite answer options; and
inputting, to the LLM, the conformal prediction set and obtaining an answer to the received problem input, wherein the conformal prediction set includes the answer to the received problem input.

16. The system according to claim 15, wherein the generating of the conformal prediction set comprises:
defining an expected set size and a coverage guarantee for an initial problem characterizing an optimal score function and a threshold;
obtaining estimates for the expected set size and the coverage guarantee;
generating a revised problem characterizing the optimal score function and the threshold;
differentiating an objective and constraint of the revised problem by introducing surrogates and obtaining plugin estimates using the surrogates;
replacing the expected set sizes by surrogates to transform to an unconstrained problem;
introducing regularization to generate a modified problem characterizing the optimal score function and the threshold;
solving the modified problem on training dataset to yield a score function and threshold; and
estimating a new threshold on a separate calibration set.

17. The system according to claim 15, wherein the score function generates a score for each of the first set of finite answer options and identifies at least one incorrect answer among the first set of finite answer options.

18. A non-transitory computer readable medium configured to store instructions for performing a conformal prediction on an initial set of finite options provided to a large language model (LLM), the instructions, when executed, cause a processor to perform the following:
receiving, via the LLM, a problem input in natural language, including a question or prompt to select among a finite set of answer options as well as the answer options themselves;
generating, via the LLM, a plurality of logits, wherein each of the plurality of logits correspond to the first set of finite answer options;
generating, by executing a conformal prediction optimization (CP-OPT) framework, a score function for the LLM;
generating, via the score function, a conformal prediction set based on the first set of finite answer options, wherein the conformal prediction set has a second set of finite answer options that is less than the first set of finite answer options; and
inputting, to the LLM, the conformal prediction set and obtaining an answer to the received problem input, wherein the conformal prediction set includes the answer to the received problem input.

19. The non-transitory computer readable medium according to claim 18, wherein the generating of the conformal prediction set comprises:
defining an expected set size and a coverage guarantee for an initial problem characterizing an optimal score function and a threshold;
obtaining estimates for the expected set size and the coverage guarantee;
generating a revised problem characterizing the optimal score function and the threshold;
differentiating an objective and constraint of the revised problem by introducing surrogates and obtaining plugin estimates using the surrogates;
replacing the expected set sizes by surrogates to transform to an unconstrained problem;
introducing regularization to generate a modified problem characterizing the optimal score function and the threshold;
solving the modified problem on training dataset to yield a score function and threshold; and
estimating a new threshold on a separate calibration set.

20. The non-transitory computer readable medium according to claim 18, wherein the score function generates a score for each of the first set of finite answer options and identifies at least one incorrect answer among the first set of finite answer options.
